(19) United States
(12) Patent Application Publication
(10) Pub. No.: US 2021/0071617 A1
(43) Pub. Date: Mar. 11, 2021

(54) Systems and Methods of Adiabatic Diesel Engine

(71) Applicant: Stephen Lang Dickerson, Atlanta, GA (US)

(72) Inventor: Stephen Lang Dickerson, Atlanta, GA (US)

(21) Appl. No.: 17/012,758

(22) Filed: Sep. 4, 2020

Related U.S. Application Data
(60) Provisional application No. 62/896,199, filed on Sep. 5, 2019.

(51) Int. Cl. F02F 7/00; F02F 3/00; F02B 75/28; F02B 75/32; F02F 3/16; F02B 33/04; F16C 7/02

(52) U.S. Cl. CPC F02F 7/0021; F02F 3/0076; F02B 75/282; F16C 7/02; F02F 3/16; F02B 33/04; F02B 75/32

(57) ABSTRACT

A proposed Adiabatic Diesel Engine (ADE), implements no cooling of the cylinders. The mechanism to achieve adiabatic cylinders is based on the separation of the crankcase mechanism from the cylinder mechanism. In an example implementation, the crankcase has a cross head mechanism driven by a connecting rod. The cross head mechanism drives the piston driveshaft(s) through a sliding bearing. The piston driveshaft moves between the crankcase and the cylinders. The cylinder has both a top where compression and combustion occur and a bottom with the piston driveshaft attached. The bottom has an opening for the piston driveshaft to move through. The bottom of the cylinder would normally be used to pump air for charging the combustion chamber. The crankcase mechanism contains lubricating oil and typically is cooled naturally through its casing.

### CROSS REFERENCE TO RELATED APPLICATIONS

This application claims benefit to U.S. provisional patent application Ser. No. 62/896,199, filed on Sep. 5, 2019, which is incorporated by reference herein.

### TECHNICAL FIELD

The present disclosure is generally related to internal combustion engines and, more particularly, is related to systems and methods of adiabatic diesel engine.

### BACKGROUND

A diesel engine is an internal combustion engine in which ignition of the fuel, which is injected into a combustion chamber, is caused by the elevated temperature of the air in the cylinder due to mechanical compression. If the diesel is adiabatic the process occurs without transfer of heat between the combustion chamber and its surroundings. In an adiabatic process, energy is transferred to the surroundings only as work, although the exhaust gases also transfer energy in the form of heat.

Diesel engines work by compressing only the air. This increases the air temperature inside the cylinder to such a high degree that atomized diesel fuel injected into the combustion chamber ignites spontaneously. With the fuel being injected into the air just before combustion, the dispersion of the fuel is uneven; this is called a heterogeneous air-fuel mixture. The process of mixing air and fuel happens almost entirely during combustion and the oxygen diffuses into the flame, which means that the diesel engine operates with a diffusion flame. The torque produced by an internal combustion engine may be controlled by manipulating the air flow. Instead of throttling the intake air, a diesel engine relies on altering the amount of fuel that is injected, and the air ratio is usually high.

A diesel engine has the highest thermal efficiency (engine efficiency) of any practical internal or external combustion engine due to its very high expansion ratio and inherent lean burn which enables heat dissipation by the excess air. In a gasoline engine, the fuel-air mixture is compressed to about a tenth of its original volume. But in a diesel engine, the air is compressed by anything from 14 to 25 times, for example. Compressing a gas generates heat, usually at least 500° C. (1000° F.) and sometimes very much hotter. The air is so hot that the fuel instantly ignites and explodes without any need for a spark plug. This controlled explosion makes the piston push back out of the cylinder, producing the power that drives the vehicle or machine in which the engine is mounted. In a four-cycle engine, when the piston goes back into the cylinder, the exhaust gases are pushed out through an exhaust valve and the process repeats itself—hundreds or thousands of times a minute. In a two-cycle engine, both the air and exhaust gases move in and out of the cylinder when the piston is pushed back. There are heretofore unaddressed issues in diesel engine efficiency.

### SUMMARY

Embodiments of the present disclosure provide systems and methods of adiabatic diesel engine. Briefly described in architecture, one embodiment of the system, among others, can be implemented by at least a cylinder with a first combustion section and a second air pump section; and a piston configured to dynamically separate the first combustion section from the second air pump section, the piston comprising no piston rings.

Embodiments of the present disclosure can also be viewed as providing methods for adiabatic diesel engine. In this regard, one embodiment of such a system, among others, can be implemented by at least a crankcase mechanism comprising a cross head mechanism, the cross head mechanism comprising a connecting rod configured to drive a sliding bearing; and a separate cylinder mechanism comprising at least one cylinder and containing lubricating oil.

Other systems, methods, features, and advantages of the present disclosure will be or become apparent to one with skill in the art upon examination of the following drawings and detailed description. It is intended that all such additional systems, methods, features, and advantages be included within this description, be within the scope of the present disclosure, and be protected by the accompanying claims.

### BRIEF DESCRIPTION OF THE DRAWINGS

FIG. 1 is a system diagram of an example embodiment of a system of adiabatic diesel engine.

FIG. 2 is a system diagram of an example embodiment of a system of adiabatic diesel engine in a dual piston, single chamber configuration.

FIG. 3 is system diagram of an example embodiment of a system of adiabatic diesel engine in a dual piston, u-shape configuration.

### DETAILED DESCRIPTION

Embodiments of the present disclosure will be described more fully hereinafter with reference to the accompanying drawings in which like numerals represent like elements throughout the several figures, and in which example embodiments are shown. Embodiments of the claims may, however, be embodied in many different forms and should not be construed as limited to the embodiments set forth herein. The examples set forth herein are non-limiting examples and are merely examples among other possible examples.

A proposed Adiabatic Diesel Engine (ADE), implements no cooling of the cylinders, but cools the lubricating oil in the crankcase, typically through the crankcase walls without a special cooling mechanism. The mechanism to achieve adiabatic cylinders is based on the separation of the crankcase mechanism from the cylinder mechanism. In an example implementation, the crankcase has a cross head mechanism driven by a connecting rod. The cross head mechanism drives the piston driveshaft(s) through a sliding bearing in the separating disk. The piston driveshaft moves between the crankcase and the cylinders. The cylinder has both a top, where compression and combustion occur, and a bottom with the piston driveshaft attached. The bottom has an opening for the piston driveshaft to move through. The bottom of the cylinder may be used to pump air for charging the combustion chamber. For example, an external tank holds pumped air from the bottom of the cylinders. That tank may feed the incoming air to the top of the cylinders when the piston is low. The crankcase mechanism contains lubricating oil and typically is cooled naturally through its casing as in the standard internal combustion engine.

Because of this arrangement, there is negligible force between the cylinder walls and the pistons because the only forces on the piston are parallel to the cylinder walls. Thus, with proper choice of materials, including diesel fuel, no lubrication of the piston within the cylinder is required. Potential materials include monolithic ceramic composite for the pistons and zirconia coatings on the cylinder heads and cylinder liners. No piston rings are required in the most advanced versions, although a compression ring could be used. Any leakage of gases around the piston is into the chamber pumping air for later combustion. The piston may have no piston rings as the leakage around the piston does not get into the atmosphere or the crankcase. Thus, leakage around the pistons is of minimal consequences, other than reduction of produced crankshaft power. Further, the cylinder mechanism with proper choice of materials does not require cooling, hence the term adiabatic, meaning no active cooling of this version of an internal combustion engine. Oil in the crankcase would be naturally cooled as in a standard internal combustion engine (ICE). In an example embodiment, lubricating oil may be eliminated in the cylinder section. The connecting rod may slide thru a port in the cylinder with oil removal rings from the crankcase to the cylinder. The port is part of a separation plate that prevents flow of gas into or out of the cylinder section. In the following discussion the gas flows discussed are the usual flows in an internal combustion engine, air in and exhaust out. There are additional flows involved in compressing air.

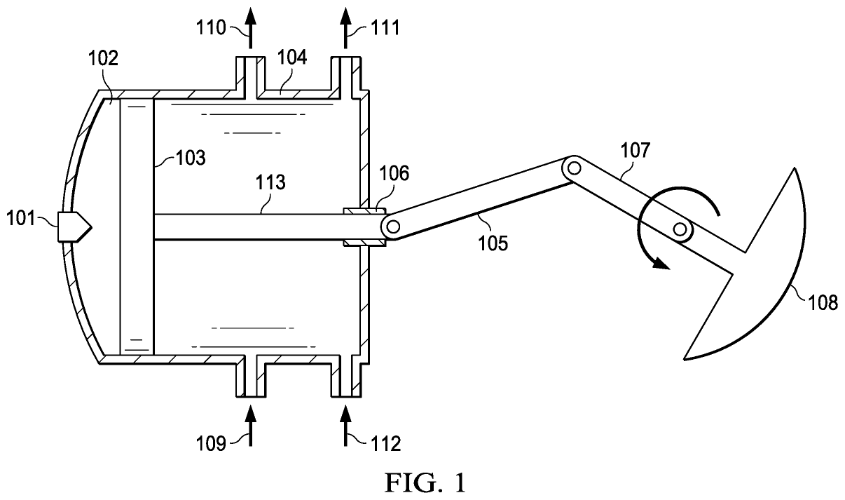

There are several variations on the geometry that include at least one crankshaft and at least one cylinder. In a first example embodiment as shown in FIG. 1, the crankshaft and cylinder(s) is (are) arranged like most internal combustion engines, referred to as a standard design. Diesel fuel injector 101 injects fuel into combustion chamber 102. Piston 103, with drive shaft 113 attached, moves in and out of cylinder 104. Cylinder 104 has a bottom and top with penetration of driveshaft 113 into the bottom of cylinder 104. Connecting rod 105 is connected to piston 103 through crosshead bearing 106. Cross head bearing 106 may use oil lubrication from the crankcase. Crankshaft 107 is connected to connecting rod 105 and crankshaft 107 spins around a pivot point to move piston 103 in and out of cylinder 104. In an example embodiment, counterweight 108 on crankshaft 107 minimizes dynamic forces during rotation. Gas port 109 provides flow of air into the top of cylinder 104. Gas port 110 provides output flow of combustion gas from cylinder 104. Because these flows take place only when the piston is near its bottom, a system of valves may be provided. When piston 103 moves toward injector 101, air is pulled into the bottom of cylinder 104 through input port 112. That air is compressed when cylinder 104 moves away from injector 101. The compressed air may exit through port 111 to an external storage tank for later flow through port 109 when piston 103 is near the bottom of its stroke.

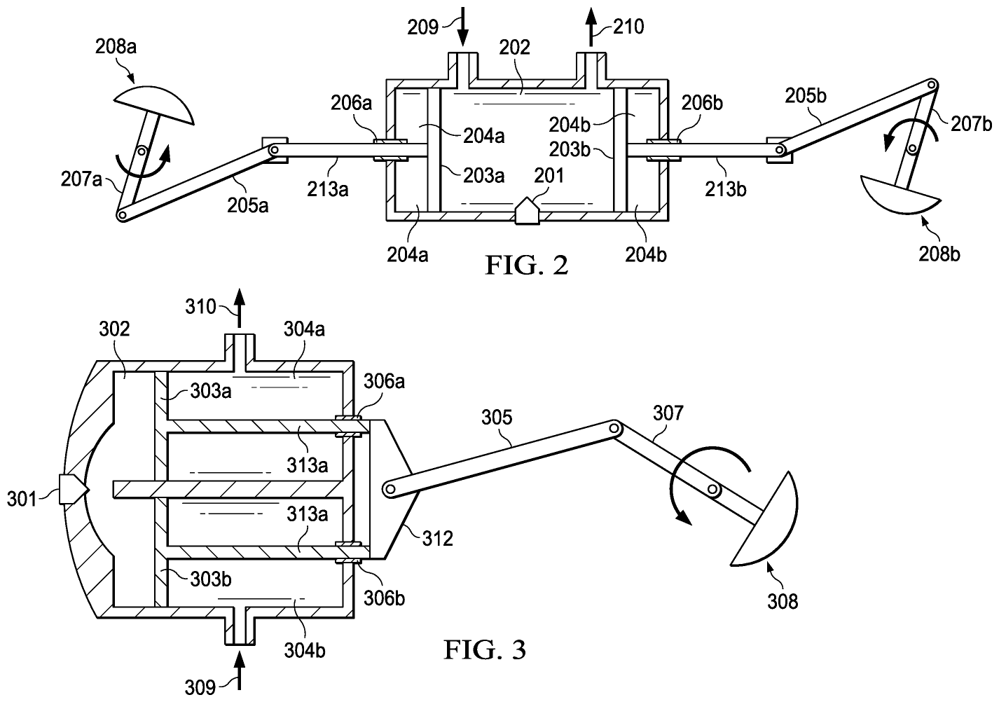

A second example embodiment, shown in FIG. 2, using the same basic parts of FIG. 1, includes an arrangement with two crankshafts 207a, 207b propelling two pistons 203a, 203b in a single cylinder 202. This is an Achates Power approach and may be referred to as a two-piston design. Diesel fuel injector 201 injects fuel into combustion chamber 202. Pistons 203a, 203b, with drive shafts 213a, 213b attached, move in and out of respective cylinder sections 204a, 204b. Cylinder sections 204a, 204b have an inner section and an outer section with driveshaft penetration into the outer sections. Drive shafts 213a, 213b are connected to pistons 203a, 203b, respectively, through crosshead bearing 206a, 206b. Cross head bearing 206a, 206b may be oil lubricated with oil from the crankcase mechanism. Crankshafts 207a, 207b are connected to connecting rods 205a, 205b, respectively, and crankshafts 207a, 207b spin around pivot points to move pistons 203a, 203b in and out of cylinder sections 204a, 204b. Counterweights 208a, 208b on crankshafts 207a, 207b minimize dynamic forces during rotation. The two crankshafts 207a, 207b may be tied together by gears or timing belts to be coordinated in their motion so that compression is maximized. As discussed with FIG. 1, there are additional ports near the ends of the cylinders to allow pumping of air. FIG. 2 does not show those ports.

A third example embodiment, shown in FIG. 3, using the same basic parts of FIG. 1, includes an arrangement with one crankshaft 307 propelling two pistons 303a, 303b per connecting rod 305 in a U-shaped dual cylinder. This may be referred to as a two piston U design. In an example embodiment, connecting rod 305 pushes bridge beam 312, bridge beam 312 connected to both the top and bottom drive shafts (or push rods) 313a, 313b driving the two pistons 303a, 303b, respectively. Drive shafts 313a, 313b for piston(s) 303a, 303b may be of crosshead design. Crosshead guide 312 may guide push rods 313a, 313b through cross head bearings 306a, 306b respectively when pushed in and out by the crankshaft 307 and connecting rod 305. In an alternative embodiment, two connecting rods are used in place of crosshead guide 312.

Diesel fuel injector 301 injects fuel into combustion chamber 302. Pistons 303a, 303b, with drive shafts 313a, 313b attached, move in and out of cylinders 304a, 304b. Cylinders 304a, 304b have a bottom and top with penetration of driveshafts 313a, 313b into the bottom. Connecting rod 305 is connected to pistons 303a, 303b through crosshead bearings 306a, 306b. Crosshead bearings 306a, 306b may have active oil lubrication applied. Crankshaft 307 is connected to connecting rod 305 and crankshaft 307 spins around a pivot point to move pistons 303a, 303b in and out of cylinders 304a, 304b. Counterweight 308 on crankshaft 307 minimizes dynamic forces during rotation. As discussed with FIG. 1, additional ports may be located near the ends of the cylinders to allow for the pumping of air. FIG. 3 does not show those ports.

There are significant technical issues, related to high temperatures and the lack of active lubrication of the piston in the cylinder, but those are resolvable with modern material sciences. Benefits of the arrangement include lower cost, size, and weight of the engine, among other benefits. Thermodynamic efficiency is also an important benefit. Maintaining a uniform temperature of the adiabatic cylinder and head may be facilitated by having the cylinder assembly enclosed and using (1) heat pipe technology and/or (2) a liquid within the enclosure that is circulating. Heat pipe technologies use evaporation of a recirculating liquid and/or gas to transfer heat between the hot ends of the structure to the cooler parts. No pump is needed and the natural vibration of the engine contributes to heat dissipation. The liquid used may be matched to the equilibrium temperatures when the engine is running so that the internal pressure of the enclosure is manageable. The heat may cause the evaporation of the fluid which may flow away to regulate the cylinder temperature from the top to the bottom of the cylinder. A substantially constant temperature helps the cylinder to expand equally along the length of the cylinder. If the temperatures are substantially different at opposite ends of the cylinder, the diameter could vary. Temperature differences might hinder operation because clearances between the piston and cylinder, normally small, could vary from one end of the cylinder to the other. The equalized temperature is also much lower than would otherwise occur at the combustion or top end of the cylinder. Hence, the cylinder materials operate at lower temperatures. An alternative mechanism to equalize the temperature of the cylinders may include introducing liquid in the enclosure of the cylinder and pumping the liquid with an electrically driven pump. The operation is still adiabatic because there is no external radiator or similar device.

Various implementations and options include an engine with an uncooled cylinder with a mechanism to allow substantially zero force between the piston and cylinder walls as described hereinabove. In an example implementation, a cylinder has two sections, a combustion section and an air pump section. The piston dynamically separates the combustion section from the air pump section. In an example implementation, the piston has no piston rings. In an example implementation, the piston is shaped to minimize gas leakage around the cylinder. In an example implementation, the piston is shaped to minimize the wear of the piston and cylinder wall and minimize gas leakage around the piston by using a novel geometry of the piston walls. This novel geometry may include multiple circular grooves in the piston wall and a special taper or similar small changes in diameter of the piston from top to bottom. In an example embodiment, the diameter of the top (or higher pressure end) of the cylinder is greater than the bottom (or lower pressure end) of the cylinder to help hold the piston centered in the cylinder, using fluid dynamic effects.

In an example implementation, the cylinder has a U-shape arrangement so that two pistons, one on each side of the U, can be synchronized. An advantage of the U-shape arrangement is that air can enter on one side and exhaust exit on the other. This is one of the reasons the Achates engine has favorable features. In an example implementation, the connecting rod pushes a bridge beam between left and right push rods driving the two cylinders. In an example implementation, the push rod for the cylinder(s) is of cross head design. The U-shape design of FIG. 3 is novel by simplifying the Achates design that are not adiabatic.

In the disclosed adiabatic design, the piston and cylinder material may be capable of high strength at high temperatures and minimal change in diameter when temperature changes. The weight of the piston and all reciprocating components may be minimized. The surfaces that are “sliding” between piston and cylinder may be wear resistant in the elevated operating temperature conditions. Deposit of combustion products may help. The piston geometry may cause minimization of contact between it and the cylinder and minimize gas flow around it as provided above. The piston may include a compression ring, but the ring may cause friction and wear that may not justify its use. The ring may be used to reduce gas flow around the cylinder. High gas flows reduce power generation and should be avoided.

Combustion chamber gases typically flow in and out of the bottom of the combustion chamber and the pressure across the valves at the bottom of the combustion chamber is relatively small compared to pressure across the valves at the top of the combustion chamber, if they exist. An example embodiment employs valves actuated by electric servo devices. Electric drivers provide both lower cost and dynamic timing controlled by microcontrollers. Example servo drive motors include moving coil motors similar to those that drive audio speakers. A common method of flow into and out of the combustion chamber is through ports in the piston walls. This requires a longer piston and is an alternative to the electrically controlled valves.

There are four flows of interest: (1) the input of air below the piston as it rises and creates suction, (2) the output of compressed air as the piston moves down, (3) the output of combustion products when the piston is down (normally called exhaust gas), and (4) the input of air above the piston when the piston is down, which is to be compressed for the next combustion cycle (often called input gas). Control of these flows requires valves properly controlled in their motion to become open or closed. Because of the relatively small pressure that is experienced across the valves (mostly located at the bottom of the cylinder), it is practical to take advantage of novel valve mechanics (such as a non-limiting example of thin film-based valves) and electric drives of the valves.

In an example embodiment, the valves are moved under electric servo control, the valves including a thin band of material with small holes spaced to align with holes in a stationary manifold. If the valve holes are totally misaligned, the valve is closed. Thus there is no mechanical connection to the crankshaft as in most motors. The electric servo control enables variable timing under microcomputer control in reaction to such external variables as motor speed, crankshaft position, and needed explosive power. This mechanism also provides for lower engine cost and weight.

Referring to FIG. 2, for example, both pistons 203a and 203b are used to compress air. Piston 203b provides exhaust gases at port 210 at substantially the same time as piston 203a takes in the air supply at port 209 for the upcoming cycle. Thus, the valve(s) for piston 203b control flow to the exhaust system and flow to a compressed gas storage tank (not shown but a spherical tank may be used) and flow from the atmosphere. Exhaust flow and air input for combustion occurs while the piston is near the bottom of the combustion cycle. These flows are above the piston. In an example embodiment, air input below the pistons occurs during the upward motion of the pistons and air compression occurs during the downward motion of the pistons It should be noted that the piston thickness (in the direction of motion) has an influence on where the gas flow openings are located on the piston walls. Because of the air compression feature of the pistons, the air flow openings are lower than the input of combustion air and the output of combustion products. These two ports are not illustrated.

In an example embodiment, valves for piston 203a control flow of air to the cylinders for combustion from a compressed gas storage tank (not shown but a spherical tank may be used). With a two piston arrangement as provided in FIG. 2, the flows for combustion from port 209 and from combustion from port 210 are geometrically widely separated and, thus, it is simpler to renew a large portion of the air for the next cycle. In a diesel engine, fuel is provided at full compression and the pollution of air with unburned fuel is easily controlled. Various fuels may be used for a diesel engine. As extreme examples, the fuel could be a pure vegetable product or liquid hydrogen. Even two different fuels may be used, typically with two different injectors. Selection of renewable fuels such as from vegetation may help with atmospheric carbon issues.

It is noted that the description provided herein does not address typical ordinary issues such as (1) how airflow and exhaust flow are regulated by valves; (2) how the driveshaft is supported by bearings within the crankcase; and (3) external features such as a tank to hold compressed air and mufflers. These functions are to be provided for but not discussed herein.

It should be emphasized that the above-described embodiments of the present disclosure, particularly, any “preferred” embodiments, are merely possible examples of implementations, merely set forth for a clear understanding of the principles of the disclosure. Many variations and modifications may be made to the above-described embodiment(s) of the disclosure without departing substantially from the spirit and principles of the disclosure. All such modifications and variations are intended to be included herein within the scope of this disclosure and the present disclosure and protected by the following claims.

Therefore, at least the following is claimed:

1. An adiabatic diesel engine system comprising:
a crankcase mechanism containing lubricating oil and comprising a crosshead mechanism, the crosshead mechanism comprising a connecting rod configured to drive a sliding bearing; and
a separate cylinder mechanism comprising at least one cylinder and containing no lubricating oil.

2. The system of claim 1, wherein the sliding bearing is connected to a piston driveshaft.

3. The system of claim 2, wherein the piston driveshaft is configured to move between the crankcase and the at least one cylinder.

4. The system of claim 2, wherein the at least one cylinder comprises a top section where compression and combustion occur and a bottom section where the piston driveshaft moves through the sliding bearing.

5. The system of claim 4, wherein the piston driveshaft is configured to move through an opening in the bottom of the cylinder mechanism.

6. The system of claim 1, wherein the crankcase is configured for cooling through a crankcase enclosure.

7. The system of claim 1, comprising a piston configured within the at least one cylinder, wherein any force on the piston is parallel to walls of the cylinder.

8. The system of claim 1, wherein the crankcase mechanism comprises two crankshafts and the cylinder mechanism comprises two pistons configured in one chamber.

9. The system of claim 8, wherein the two crankshafts are tied together by gears and/or timing belts for motion coordination.

10. The system of claim 1, wherein the crankcase mechanism comprises one crankshaft and the cylinder mechanism comprises two pistons configured in separated chambers.

11. The system of claim 10, wherein the crankcase mechanism comprises a bridge beam, the bridge beam connected to both a left and right push rod.

12. The system of claim 10, further comprising two connecting rods configured to drive the two pistons.

13. The system of claim 1, further comprising a heat pipe configured to maintain a uniform temperature of the cylinder mechanism.

14. The system of claim 1, further comprising a wrapping wick and container configured to maintain a uniform temperature of the cylinder mechanism.

15. An adiabatic diesel engine system comprising:
a cylinder with a first combustion section and a second air pump section; and
a piston configured to dynamically separate the first combustion section from the second air pump section, the piston comprising no piston rings.

16. The system of claim 15, wherein the piston is configured in a shape to minimize gas leakage around an inner wall of the cylinder.

17. The system of claim 15, wherein the piston is configured in a shape to minimize the wear of the piston and an inner wall of the cylinder.

18. The system of claim 17, wherein the shape comprises multiple circular grooves in the piston.

19. The system of claim 17, wherein the shape comprises a taper in diameter from top to bottom of the piston.

20. The system of claim 15, wherein the cylinder is configured in a U-shape with two pistons, one on each side of the U, which are synchronized.
